(19) United States
(12) Patent Application Publication
(10) Pub. No.: US 2005/0184859 A1
(43) Pub. Date: Aug. 25, 2005

(54) Ultrasonic detector installable on a truck trailer

(76) Inventor: Shih-Hsiung Li, Taipei (TW)

Correspondence Address: VARNDELL & VARNDELL, PLLC, 106-A S. COLUMBUS ST., ALEXANDRIA, VA, 22314, US

(21) Appl. No.: 10/780,870

(22) Filed: Feb. 19, 2004

(51) Int. Cl. B60Q 1/00

(52) U.S. Cl. 340/435; 340/431

(57) ABSTRACT

An ultrasonic detector installable on truck trailer is provided, consisting of a console unit installed in the driver compartment of the vehicle, and multiple ultrasonic detection units mounted on the rear section of the vehicle body. Each ultrasonic detection unit comprises four transceivers, a storage battery and a recharge circuit. Data communication between the ultrasonic detection units and the console unit is accomplished through a cable interface or RF interface. When an object is detected in the preset warning range, the alarm is initiated to warn the driver. A special connector is used to adapt the night light of the vehicle so as to be able to use the electricity of the night light to power the transceivers of the ultrasonic detection units.

### BACKGROUND OF THE INVENTION

1. Field of the Invention

The present invention is related to an ultrasonic detector installable on a truck trailer, and more particularly to an ultrasonic detection apparatus that can be easily installed on the rear section of the truck trailer, ingeniously adapting an existing power source of the vehicle to power the transceivers of the ultrasonic detection apparatus.

2. Description of Related Art

Most passenger vehicles on the road are now equipped with electronic backing-up detectors, but large vehicles still rely on the conventional rear view and wing mirrors to check road conditions behind the vehicles. These large vehicles are not that easy to maneuver like passenger vehicles because of the extended length and bulkiness of the vehicle body, so these vehicles have a more pressing need to use electronic detectors that may provide extra guidance in parking and backing up. However, one of the problems in installing electronic backing-up detectors on special purpose vehicles such as truck trailers is how to power the backing-up detectors when a power source is not readily available on the rear section of the truck trailer. Conventionally, backing-up detectors draw electricity from the backing-up light of the vehicle, but the truck trailer does not have backing-up tail lights on the rear section.

One alternative is to use a storage battery in the backing-up detector configuration. Although the backing-up detector can obtain a power source using this method, the battery only provides limited operation time. Following this line of thinking, there are other problems, such as how to check the battery status and how to relate the battery status to the driver. The backing-up detector will stop functioning after the battery is depleted, but the driver would not know that the backing-up detector is out of service simply because of a battery problem.

Special design efforts need to be made if a storage battery is to be used to provide necessary power for the backing-up detector if it is to be used on a truck trailer.

### SUMMARY OF THE INVENTION

The main object of the present invention is to provide an ultrasonic detector that can be easily installed on the rear section of special vehicles such as truck trailers, which comes with a special connector to adapt an existing power source used by the vehicle to power the transceiver operation.

To this end, the configuration of the ultrasonic detector comprises:
a console unit being installed in the driver compartment of the truck trailer; and
multiple ultrasonic detection units being installed on the rear section.

Each ultrasonic detection unit has multiple transceivers and a controller chip. The transceivers are used to emit ultrasonic waves, receive reflected wave signals, and convert the reflected signals to pulse signals for further processing by the controller chip.

Pulse signals from all ultrasonic detection units will eventually converge on the console unit, where the pulse signals are processed by the microprocessor to calculate the closest distance between the object and the vehicle body, and to determine if the object is within a preset warning range, so as to issue a warning to the driver. No matter whether the object is at a safe distance or not, the microprocessor regularly forwards the distance information to a digital display.

The data communications between multiple ultrasonic detection units and the console unit can be implemented either through an RF interface or a cable interface, both of which are built into the control circuitry of the detector.

The ultrasonic detection unit is formed by a controller chip, multiple transceivers, a storage battery and a recharge circuit, wherein the storage battery is coupled to the night light of the vehicle, so that the recharge circuit draws electricity from the night light of the truck trailer to recharge the storage battery, which used to provide the operating voltage to all components in the ultrasonic detection unit.

The ultrasonic detection unit is controlled by the brake light of the truck trailer. Whenever the brake light is enabled, the transceivers of the ultrasonic detection units will be switched to the active state to emit ultrasonic signals, receive reflected signals, and generate pulse signals. It shall be noted that all the above processes are to be completed in one operation cycle. When the brake light is disabled, the ultrasonic detection unit will be switched to the standby state, whereby the transceivers are disabled; and if the night light is enabled, only the storage battery will be recharged during the non-braking period.

The cable interface is responsible for data transmission between the ultrasonic detection unit and the console unit using cable media. When the cable interface is used, a bidirectional communication mode is effected between the controller chip of the ultrasonic detection unit and the console unit, but the unidirectional communication mode is still used when the controller chip detects that the brake light is enabled, in which only the controller chip of the ultrasonic detection unit is allowed to transmit the distance data to the console unit.

The RF interface is responsible for data transmission between ultrasonic detection units and the console unit through radio frequency communication. When the RF interface is used, unidirectional communication mode is effected between the ultrasonic detection unit and the console unit, which means that only the controller chip transmits the distance data to the console unit.

The console unit has a microprocessor, an alarm, a digital display, and a corresponding RF interface and cable interface.

On receiving the pulse signals, the microprocessor converts the pulse signals to the relative distance between the object and the vehicle body. If the object is within a preset warning range, the microprocessor will activate the alarm; the distance data are regularly passed to the digital display. The driver is continuously updated with the distance information to assist in parking or moving in reverse gear.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of the system architecture of the present invention;

FIG. 2 is a schematic diagram of the components in the ultrasonic detection unit;

FIG. 3 is an external view of the ultrasonic detection unit; and

FIG. 4 is a schematic diagram of the components in the console unit.

### DETAILED DESCRIPTION OF THE PREFERRED EMBODIMENT

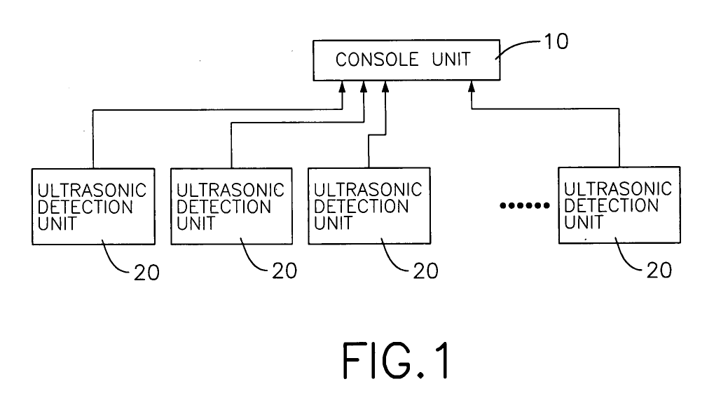

The present invention is illustrated through a preferred embodiment as shown in FIG. 1, comprising a console unit (10) and one or more ultrasonic detection units (20), wherein
the console unit (10) is installed in the driver compartment of the truck trailer; and
multiple ultrasonic detection units (20) are installed on the rear section of the truck trailer.

The console unit (10) is linked to the ultrasonic detection units (20) either through cables or wireless means, as both units (10, 20) are equipped with a respective cable interface (15) (27) and an RF interface (14) (26) for supporting different modes of data communications.

One console unit (10) collects pulse signals from all the ultrasonic detection units (20), basing on which the console unit (10) calculates the closest distance from any object, and then determines whether the object is within the preset warning range, so as to initiate the alarm to warn the driver of the object behind the vehicle.

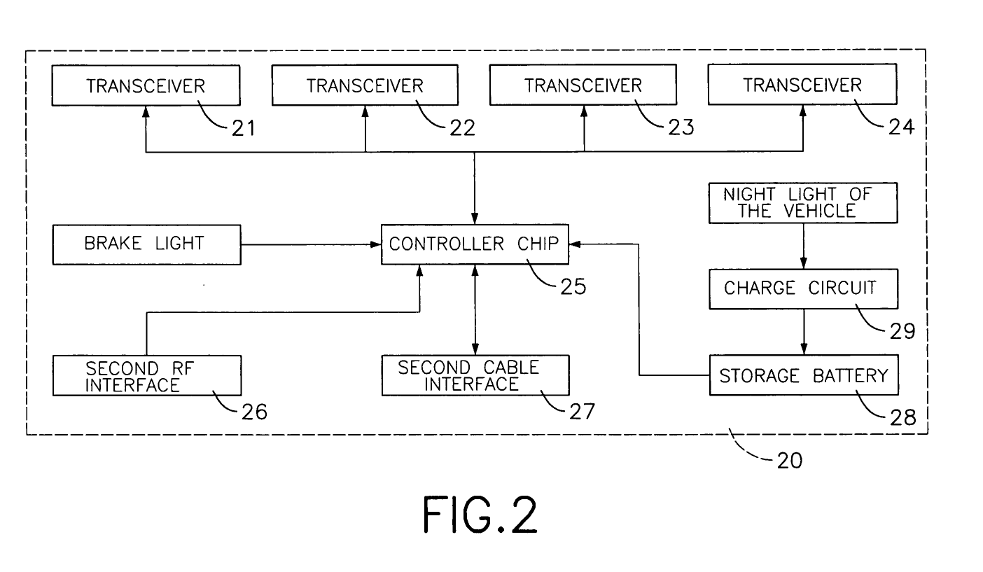

As shown by the schematic diagram of FIG. 2, the ultrasonic detection unit (20) is formed by multiple transceivers (21-24), a controller chip (25), a second RF interface (26), a second cable interface (27), a storage battery (28) and a recharge circuit (29).

The ultrasonic detection unit (20), as in the present example, uses four transceivers (21-24), where the transceivers (21-24) are used to emit ultrasonic waves, receive reflected wave signals, convert the reflected wave signals to pulse signals, and eventually pass the pulse signals to the controller chip (25) for further processing.

The controller chip (25) is to process the pulse signals received from the transceiver (21-24) to generate the relative distance. Also, the controller chip (25) is to control the sequence of firing by all transceivers (21-24), and to check the brake light of the truck trailer which is used as control signals to initiate the firing of ultrasonic waves. When the controller chip (25) detects the brake light signal, the controller chip (25) initiates an operation cycle of the transceiver (21-24) to emit ultrasonic waves (for example 10-30 sec), and then to receive reflected waves within a predetermined interval, and then to generate pulse signals to be passed to the controller chip (25). All the above processes are to be completed within one operation cycle. Then, the controller chip (25) sends them through either the second RF interface (26) or the second cable interface (27) to the console unit. When the operation cycle of the transceivers (21-24) comes to an end, the controller chip (25) therefore switches the transceivers (21-24) to the standby state to save on power. At the same time, the controller chip (25) checks the power status of the storage battery (28), and passes that information through the second RF interface or the second cable interface (26)/(27) to the console unit (10).

The second cable interface (27) is responsible for data transmission between the controller chip (25) and the console unit (10) using the cable media. When the first and second cable interface (15) (27) are interconnected by a cable, the bidirectional communication mode is effected between the controller chip (25) and the console unit (10), whereby the controller chip (25) of the ultrasonic detection unit (20) transmits the distance data to the console unit (10), and the console unit (10) issues the instructions to the controller chip (25) of the ultrasonic detection unit (20). The unidirectional communication mode is still used when the controller chip (25) of the ultrasonic detection unit (20) detects the brake light signal, whereby only the controller chip (25) of the ultrasonic detection unit (20) is allowed to transmit the distance data to the console unit (10).

The second RF interface (26) is responsible for data transmission between the ultrasonic detection units (20) and the console unit (10) through radio frequency communication. When the first and second RF interface (14) (26) are used, unidirectional communication mode is effected between the controller chip (25) of the ultrasonic detection unit (20) and the console unit (10), which means that the controller chip (25) transmits the distance data to the console unit (10).

The storage battery (28) provides the operating voltage for all components in the ultrasonic detection unit (20). When the remaining power in the storage battery (28) falls below the minimum level, and the night light of the vehicle is enabled, the recharge circuit (29) is enabled to draw electricity from the night light of the vehicle to recharge the storage battery (28). This operation is not to be interrupted by on/off of the brake light. As the brake light and the night light are standard equipment on the trailer, the ultrasonic detector system therefore secures a reliable power source and control signals. The brake light is enabled when the brake pedal is depressed. Then, the controller chip (25) detects the brake light signal and activates the operation cycle of the transceivers (21-24).

The ultrasonic detection unit (20) has a power saving mechanism that is to switch all transceivers (21-24) from the active state to the standby state when the brake light is turned off. The brake light is on only when the brake pedal is depressed, so that the braking time is quite brief in each interval and randomly scattered over a given period of time. Most of the time, the detector operation just lasts for one or two operation cycles. Therefore, on the average, the braking time is relatively short as compared with the night light illumination time. Therefore the storage battery (28) charge shall be sufficient to meet the power requirement of the ultrasonic detection unit (20), and to maintain the normal operation of the ultrasonic detection unit (20).

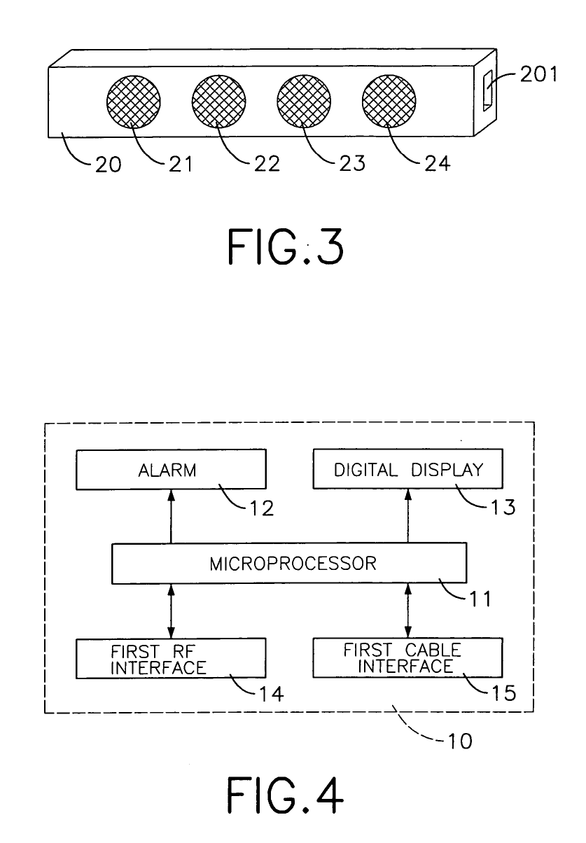

As shown in FIG. 3, the ultrasonic detection unit (20) has multiple transceivers (21-24) aligned through holes, a storage battery (28), a controller chip (25) and a control circuitry consisting of a second RF interface (26), a second cable interface (27), and a recharge circuit (29), all embedded in the casing. The second cable interface (27) of the ultrasonic detection unit (20) is connected to a power source through a special connector (201). When the ultrasonic detection unit (20) uses the cable transmission, the special connector (201) is connected to the second cable interface (27) of the ultrasonic detection unit (20) leading to a communication cable, and the special connector (201) is also coupled to the brake light and the night light. When the ultrasonic detection unit (20) uses the second RF interface (26), the special connector (201) is connected to the brake light and the night light, eliminating the use of the second cable interface (27).

The casing of the ultrasonic detection unit (20) is mounted on the rear section of the vehicle body by screws or other fastening means.

As shown in FIG. 4, the console unit (10) is formed by a microprocessor (11), an alarm (12), a digital display (13), a first RF interface (14) and a first cable interface (15).

The microprocessor (11) collects the pulses from all outlying ultrasonic detection units (20) through the first RF interface/first cable interface (14)/(15), and then processes the pulses to generate the closest distance between the object and the vehicle body. The microprocessor (11) also obtains the power data from all ultrasonic detection units (20) to determine whether the remaining power in the storage battery (28) of each ultrasonic detection unit (20) is sufficient to maintain normal operation. If the remaining power is found to be below the minimum level, the microprocessor (11) issues a warning through the digital display (13).

The digital display (13) is used to present the relative distance between the object and the vehicle body. The digital display can be a seven-segment LED or LCD display. The digital display (13) receives the relative distance data from the microprocessor (11) and presents the distance information to the driver.

The alarm (12) can be a buzzer. Under the control of the microprocessor (11), the alarm (12) emits beeping sounds with different frequencies to reflect the closeness of the object to the vehicle body. The frequency and the pitch will increase as the vehicle approaches the object; and likewise the frequency and pitch will decrease when the distance between the vehicle and the object increases. The alarm (12) will stop when the object is beyond the preset warning range.

The first RF interface (14) is responsible for the data transmission between the microprocessor (11) and the ultrasonic detection unit (20) through radio frequency communication. When the RF interface (14) is used, the unidirectional communication mode is effected between the console unit (10) and the ultrasonic detection unit (20), that is, the channel is only open for the ultrasonic detection unit (20) to transmit the distance data and the battery data to the console unit (10).

The first cable interface (15) is responsible for data transmission between the microprocessor (11) and the ultrasonic detection unit (20) through cable media. When the first cable interface (15) is used, the bidirectional communication mode is effected between the console unit (10) and the ultrasonic detection unit (20), that is, the console unit (10) receives the distance data from the ultrasonic detection unit (20), and at the same time, the console unit (10) issues instructions to the ultrasonic detection unit (20); but it could also operate in unidirectional mode. In that case, the channel is open for the ultrasonic detection unit (20) to transmit the distance data to the console unit (10).

From the foregoing, the present design ingeniously uses a special connector to allow the ultrasonic detector to adapt the brake light of the vehicle to obtain necessary control signals for initiating the operation of the transceivers, and the special connector is also connected to the night light to secure a reliable power source, in consideration of the fact that the truck trailers usually do not have back-up lights on the tail end. Also, the present invention provides an option to use either wireless means or cable for data transmission between outlying ultrasonic detection units and the console unit, as the necessary communications interfaces are built into the ultrasonic detector. This is a user choice, so the back-up detector can be custom made to match the actual needs.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An ultrasonic detector installable on a truck trailer fitted with a night light, comprising a console unit (10) and at least one ultrasonic detection unit (20); wherein
the at least one ultrasonic detection unit (20) emits ultrasonic waves, receives reflected wave signals within a predetermined time, and converts the wave signals to pulse signals; and
the console unit (10) collects pulse signals from the at least one ultrasonic detection unit (20), and then generates the distance data to be displayed through a digital display (13) and to determine whether to activate an alarm (12) to warn the driver of a reducing distance between the truck trailer and any object.

2. The ultrasonic detector according to claim 1, wherein the at least one ultrasonic detection unit has a controller chip (25), multiple transceivers (21-24), a second RF interface (26), a second cable interface (27), a storage battery (28) and a recharge circuit (29).

3. The ultrasonic detector according to claim 1, wherein the cable interface (15) of the console unit (10) and the cable interface (27) of the at least one ultrasonic detection unit (20) are to be interconnected by a cable for bidirectional communication.

4. The ultrasonic detector according to claim 1, wherein the RF interface (14) of the console unit (10) and the RF interface (26) of the at least one ultrasonic detection unit (20) are used for establishing radio frequency communication.

5. The ultrasonic detector according to claim 1, wherein the console unit (10) has a microprocessor that is connected to an alarm (12), a digital display (13), a first RF interface (14) and a first cable interface (15).

6. The ultrasonic detector according to claim 2, wherein the controller chip (25) of the at least one ultrasonic detection unit (20) is connected to the brake light of the vehicle through a special connector (201) to obtain necessary control signals to initiate the operation cycle of the transceivers (21-24).

7. The ultrasonic detector according to claim 5, wherein the alarm (12) is a buzzer.

8. The ultrasonic detector according to claim 5, wherein the digital display (13) is a seven-segment LED display.

9. The ultrasonic detector according to claim 5, wherein the digital display (13) is an LCD display.

10. The ultrasonic detector according to claim 5, wherein the recharge circuit (29) of the ultrasonic detection unit (20) is coupled to the night light on the truck trailer through a special connector (201), through which the storage battery (28) gets recharged using electricity from the night light of the truck trailer.

11. The ultrasonic detector according to claim 1, wherein each ultrasonic detection unit (20) has the second cable interface (27), the storage battery (28) and the recharge circuit (29) respectively connected to a communication cable, a brake light and night light of the truck trailer through the special connector (201).

12. The ultrasonic detector according to claim 6, wherein each ultrasonic detection unit (20) has the second cable interface (27), the storage battery (28) and the recharge circuit (29) respectively connected to a communication cable, a brake light and night light of the truck trailer through the special connector (201).
